(19) United States
(12) Patent Application Publication
(10) Pub. No.: US 2002/0048425 A1
(43) Pub. Date: Apr. 25, 2002

(54) Microfluidic optical electrohydrodynamic switch

(75) Inventors: Sterling Eduard McBride, Lawrenceville, NJ (US); Peter John Zanzucchi, Princeton Junction, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/874,886

(22) Filed: Jun. 5, 2001

Related U.S. Application Data
(60) Provisional application No. 60/234,041, filed on Sep. 20, 2000.

(51) Int. Cl. G02B 6/35

(52) U.S. Cl. 385/16

(57) ABSTRACT

An apparatus for switching an optical signal comprising a first optical waveguide, a second optical waveguide aligned with the first and a third optical waveguide intersecting the previously mentioned pair. At the region of intersection of the waveguides, a microchannel containing a liquid is disposed. Also included in the microchannel is an electrokinetic pump used to move the fluid into and out of the microchannel.

### CROSS-REFERENCE TO RELATED APPLICATIONS

This application claims benefit of United States Provisional Patent Application Ser. No. 60/234,041, filed Sep. 20, 2000, which is herein incorporated by reference.

### BACKGROUND OF THE INVENTION

The present invention relates to an apparatus and accompanying method for switching or redirecting optical signals. More particularly, this invention relates to a method and apparatus for switching optical signals using electrohydrodynamic properties of a fluid.

While signals within telecommunications and data communications networks have been traditionally exchanged by transmitting electric signals via electrically conductive lines, an alternative medium of data exchanged is the transmission of optical signals through optical fibers. To effectively route optical signals through a fiber optic network, optical switches are used. Optical switches are generally fabricated of a crystalline material such as silicon. Small silicon mirrors have been fabricated and actuated by an electric field to facilitate switching. Crystal materials can be fragile and be susceptible to environmental changes. Consequently, there is a need in the art for alternative forms of optical switches.

### SUMMARY OF THE INVENTION

The present invention provides a microfluidic optical switch in which an optical signal is switched using electrohydrodynamic principles. The microfluidic optical switch comprises a plurality of intersecting optical waveguides formed on a substrate, interrupted by a microchannel formed across both the intersecting waveguides at their intersections. More specifically, a first optical waveguide bisected by the microchannel. At the bisection point, a second optical waveguide intersects the first optical waveguide at a predefined angle to the first waveguide. In one embodiment of the invention, an electrohydrodynamic (EHD) pump is located in the microchannel at the intersection of the waveguides. The EHD pump moves a fluid having a refractive index similar to that of the waveguide material into and out of the microchannel and across both intersecting waveguides.

The microfluidic optical switch is based on the change of the reflection and transmission characteristics of the interface caused by the movement of the fluid. The interface can be made completely reflective and transmissive by changing the refractive index of the material at the interface.

The EHD pump is activated by an electrical signal that causes the fluid to be transported in the microchannel and across both intersecting waveguides. When the fluid is not in the microchannel across both of the intersecting waveguides, total internal reflection is attained, and light being applied through the first waveguide is reflected into the second waveguide. When the fluid is caused to enter the intersection across both intersecting waveguides, the index of refraction of the waveguide and the index of refraction of the fluid are substantially similar such that total transmission of the light beam through the interface and into the first waveguide occurs. By moving fluid in and out of the intersection between the waveguides, a switching effect is realized.

### BRIEF DESCRIPTION OF THE DRAWINGS

The foregoing summary, as well as the following detailed description of the preferred embodiments of the invention, will be better understood when read in conjunction with the appended drawings. It should be understood, however, that the invention is not limited to the precise arrangements and instrumentation shown. In the drawings:

FIG. 1 depicts a perspective view of an embodiment of an optical switch of the present invention;

FIG. 2 is a top view of the optical switch of FIG. 1 operating in a first state;

FIG. 3 is a top view of the optical switch of FIG. 1 operating in a second state;

FIGS. 4A-4F are a series of drawings of an electrohydrodynamic actuator and micro-channel showing the position of the air-fluid interface during fluid movement created by the electrohydrodynamic actuator; and

FIG. 5 is a top view of another embodiment of the optical switch according to the present invention.

To facilitate understanding, identical reference numerals have been used, where possible, to designate identical elements that are common to the figures.

### DETAILED DESCRIPTION

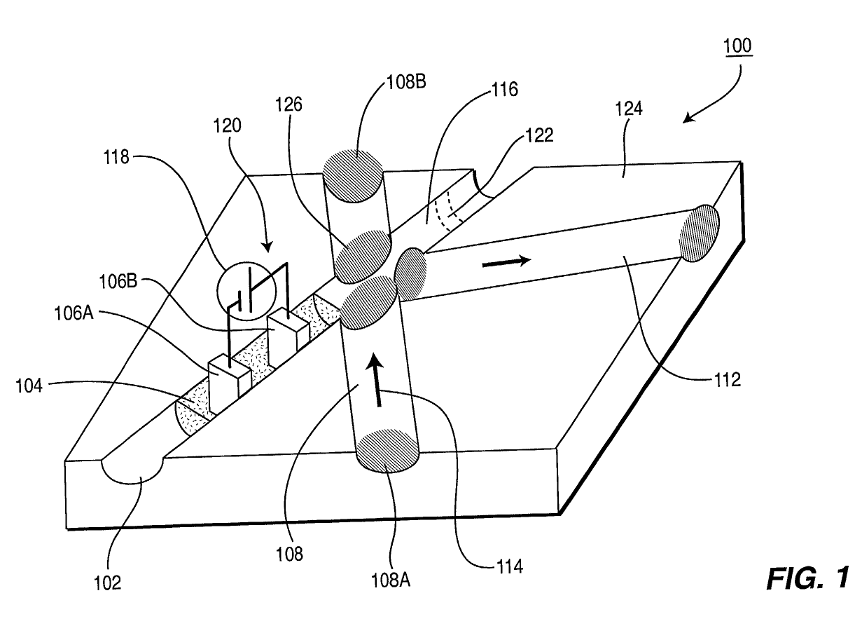

FIG. 1 is perspective sectional view of an optical switch 100 according to the present invention. In one embodiment, the invention is formed on a substrate 124. The substrate 124 may be formed of any suitable material, preferably a GaAs substrate, but other materials, such as glass, silica GaAs, ZnGaAs, ZnGaAsP or silicon. The GaAs in GaAs silicon may be used. The advantages of a GaAs substrate are that are compatible with current optical devices.

The optical switch 100 comprises a plurality of planar optical waveguides 108 and 112, a microchannel 102, an electrode-based actuator 120 and a fluid 104.

A first waveguide 108 is bisected by the microchannel 102 at region 126. A second waveguide 112 intersects the first waveguide 108 at region 126. The electrode-based actuator 120 is located within the microchannel 102 and may be only one switch element in an array of switching elements. As described below, the electrode-based actuator 120 may be, for example, an electrohydrodynamic (EHD) pump or an electro-osmosis (EO) pump.

Also, the ability to form waveguides in GaAs and glass is well-known in the art. The ability to form a waveguide using SiO₂ on silicon substrates is also well-known in the art. The optical waveguides 108 and 112 may be formed of a material that is primarily SiO₂, but which includes another material such as Ge or TiO₂. The wall portions of the waveguides 108 and 112 may be formed of a material that is primarily SiO₂, but includes other materials. These other materials may be B₂O₃ and/or P₂O₅. Because the central or core material has a refractive index that is different from the refractive index of the outer material, optical signals will be “guided” along the optical waveguides 108 and 112.

The microchannel 102 is formed to bisect the first waveguide 108 at the region 126. The waveguides 108 and 112 intersect the microchannel 102 at an angle of incidence greater than the critical angle for total internal reflection when the microchannel is empty of fluid (e.g., filled with air at region 126). Thus, total internal reflection (TIR) diverts light from the first waveguide 108 to the second waveguide 112. The angle of the second waveguide 112, with respect to the microchannel 102, is chosen to match the angle of incidence of the first waveguide 108 on the microchannels 102, since the angle of incidence equals the angle of reflection. Typically, the angle of incidence is varies from 60°-90° between the first waveguide and the microchannel 102 intersection region. The microchannel 102 is positioned with respect to the two waveguides so that one side wall of the microchannel passes directly through the intersection of the axes of both waveguides 108 and 112. Then, light is reflected from waveguide 108 to waveguide 112 with minimal loss.

The fluid 104 has a refractive index that matches the indices of the waveguides and realizes the elimination of the reflective interface to attain transmission of light through the optical waveguide 108. The fluid may be either a composite of two immiscible fluids, one fluid having a matching refractive index of the waveguides and another fluid acting as a transport plug that may be moved by the electrode-based actuator 120 or a single fluid in a single phase system, whereby the same fluid is both the index refracting fluid and the transport plug. H₂O, silicone, or organic solvents may be used as refracting index matching fluids. The following solvents are non-limiting examples of liquids useful to form the transport plug used to move the reflective fluid. The immiscible fluid may be, but is not limited to, toluene, chloroform, benzene, hexane, heptane and octane. The fluid can also be a single phase system (same fluid for refractive index matching and transparent plug).

The electrode-based actuator 120 is, for example, an electrohydrodynamic (EHD) pump comprising two or more electrodes 106A and 106B, a microchannel 102 and a fluid 104. When the electrodes 106A and 106B are powered to form an electric field between the electrodes, the fluid 104 is moved through the microchannel 102 across the interface region 126. The electrodes 106A and 106B are arrayed so that (a) the strongest electric field lines cross a cross-section of the channel; or (b) the electrodes are concentrically arrayed around the channel such that the strongest electric field lines parallel to the channel are on more than one face of the channel.

Without being bound by any particular theory, possible theoretical considerations in electrode-based pumping are set forth in detail in U.S. Pat. No. 5,985,119. At least two types of such electrode-based pumping have been described, typically under the names “electrohydrodynamic pumping” (EHD) and “electro-osmosis” (EO) where EO pumping is a particular case of EHD pumping.

Several theoretical concepts are believed to play a role in the mechanics of EHD pumping. The forces acting on a dielectric fluid are believed to be described by:

$$\vec{F} = q \vec{E} + \vec{P} \cdot ∇ \vec{E} - 1 / 2 {E}^{2} ∇ ϵ + ∇ [ 1 / 2 p \frac{\partial e}{\partial ρ} {E}^{2} ]$$

where F is the force density, q is the charge density, E is the applied electric field, P is the polarization vector, ε is the permittivity and p is the mass density of the fluid. Of the terms in the equation, the first and third are believed to be the most significant in the context of EHD pumping of fluids. The first term (qE) relates to the Coulomb interaction with a space-charge region. The third term (½E² ≡ε) relates to the dielectric force which is proportional to the gradient in permittivity.

In low electric fields, i.e., the Ohmic region where current is linearly proportional to voltage, the primary source of charges that will be acted upon by the electric field are believed to be primarily due to ions from additives, ions from impurities and ions formed by autodissociation of molecules in the fluid. In intermediate electric fields, i.e. from beyond the Ohmic region to about 2 V/μm, the charges are believed to be primarily formed by dissociation and electrolytic processes in the fluid. In high electric fields, the charges are believed to be determined by injection processes at the electrodes, which electrodes inject homocharges.

For the purposes of this application, positive (+) flow shall be flow in the direction from the positive (+) electrode 106B to the negative (−) electrode 106A, and negative (−) flow shall be flow in the direction from the negative (−) electrode 106A to the positive electrode 106B.

EO pumping is believed to take advantage of the principle that the surfaces of many solids, including quartz, glass and the like, become charged, negatively or positively, in the presence of ionic materials, such as salts, acids or bases. The charged surfaces will attract oppositely charged counter ions in solutions of suitable conductivity. The application of a voltage to such a solution results in a migration of the counter ions to the oppositely charged electrode, and moves the bulk of the fluid as well. The volume flow rate is proportional to the current, and the volume flow generated in the fluid is also proportional to the applied voltage. Typically, in channels of capillary dimensions (i.e., having dimensions that favor capillary flow of a liquid) the electrodes effecting flow can be spaced further apart than in EHD pumping, since the electrodes are only involved in applying force, and not, as in EHD, in creating or inducing charges on which the force will act. EO pumping is generally perceived as a method appropriate for pumping electrolyte solutions.

The present invention is believed to be applicable to all forms of electrode-based pumping. The invention is most preferably applied to electrode-based pumping where the field strength directly acts on liquid components to create pressure, as in EHD and EO pumping. The invention is also applicable to other electrode-based methods, such as traveling wave methods.

The actuator applied in the present invention can be made of simple wire electrodes. Alternatively, U.S. Pat. No. 5,842,106, filed Nov. 9, 1995 (“Method of Producing Microelectrical Conduits”) describes a method of mass producing high density microelectrodes for EHD pumps using microfabrication techniques. This application is hereby incorporated into this disclosure by reference in its entirety. These electrodes are formed on plates of dielectric material such as glass, and each such plate is bonded to a plate in which channels have been etched. See U.S. Pat. No. 5,747,169, filed Nov. 8, 1996 (“Field-Assisted Sealing”) for plate bonding methodology, which application is hereby incorporated into this disclosure by reference in its entirety.

Driving circuits useful in electrode-based pumps are set forth in U.S. Pat. No. 5,637,876, Jun. 6, 1995 (“Apparatus and Methods for Controlling Fluid Flow in Microchannels”) and U.S. Pat. No. 5,858,193, Nov. 9, 1995 (“Electrokinetic Pumping”).

The channel 102 is of capillary dimensions. The electrode-based pump 120 comprises: (a) a first electrode 106A on face of the channel 102 and a second electrode 106B on a separate face of the channel 102; or (b) two or more pairs of coupled electrodes 106 jointly located in the channel 102; or (c) electrodes 106A and 106B when at least one electrode 106 is radially arrayed along the sides of the channel 102; or (d) a first electrode 106A and a second electrode 106B arrayed so that the strongest electric field lines are substantially parallel to the direction of fluid flow in the channel 102. The strongest electric field lines are substantially parallel to the direction of liquid flow in the channel 102. The electrodes 100 may be either plate electrodes or point electrodes. Either way, the electrode 106 comprises a conductive material 106 that may be formed in the substrate 124. The outlet portion 122 of the channel 102 is a capillary barrier for inhibiting liquid flow in the absence of a voltage applied to the pump 120.

Once fluid 104 is placed into the microchannel 102, the fluid 104 comes in contact with field lines of the channel implied by applying a voltage 118 across electrodes 106, a cross-section of liquid 104 in the channel 102 or the strongest electric field lines parallel the channel on more than one face of the channel. Electrodes may be oriented in any number of orientations that can accomplish these advantageous orientations of the field lines created by the pumping electrodes.

The microchannel 102 may be formed in any suitable substrate material, such as glass or silicon, structures can be formed by chemical etching or laser ablation. Plastic structures are often formed by molding techniques. With holes formed in substrates by laser ablation, particularly holes formed in glass, when it is useful to roughen the sides of the substrate at which the hole will operate. The roughening helps limit the scope of any fracturing that occurs at the break-out site. Following the formation of such holes, the surfaces of the electrodes can be lapped and polished.

In situations where one seeks substantial selectivity in the shape of an etched microchannel, such as substantial vertical walls which can be desirable in substrate traversing channels, one can apply well-known dry etching techniques such as plasma-assisted etching.

Point electrodes are constructed by first forming, through the device in which the electrode-based pump is used, an electrical conduit for bringing a voltage to a fluid channel contacting electrode. The end of the electrical conduit can serve as the electrode, or the end can be coated with an appropriate material such as chromium, gold, silver, platinum, palladium, nickel and the like. For example, the conduit can be formed in a via such as a laser drilled via, by fusing a via ink that has been inserted into the vias using the method set forth in U.S. Pat. No. 5,842,106 (U.S. application Ser. No. 08/554,887, filed Nov. 9, 1995). The fluid channel-coating end of the conduit can, for example, be electroplated with nickel (e.g., 20 μm) followed by electroplating with gold (e.g., 0.5 μm) and then platinum (e.g., 2 μm).

The electrodes 106 themselves may also be ring electrodes. Ring electrodes could be located at the exits of the fluid channel, meaning at locations where fluid moves into a less-restrictive structure such as a microfluidic channel, wherein electrodes dictate the current distributed more evenly in the fluid channel. This arrangement of electrodes allows the fluid to flow more quickly when acted upon by the electric field.

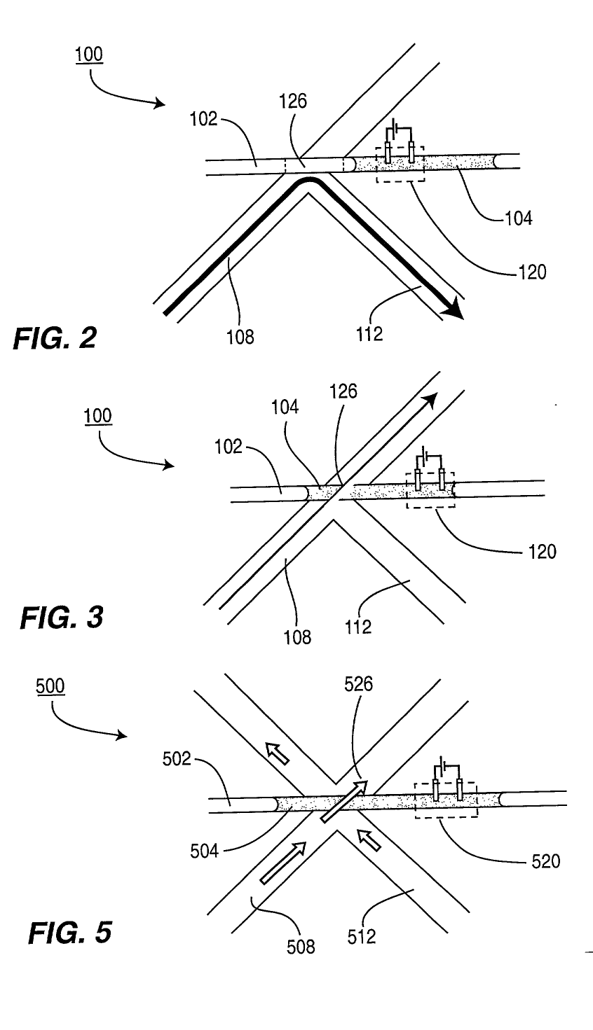

Referring to FIG. 2, FIG. 2 is a top view of the optical switch of FIG. 1. For the EHD pump 120 to move the fluid 104, a voltage is applied to the electrodes 106A and 106B. Typically, the voltage may range from approximately 30-80 V. The electrodes form an electric field in the fluid 104 that moves the fluid. Movement of the fluid occurs over a time period known as the transit time. Transit time or Tₜᵣ is defined as the time required for a plug of fluid to move the width of the interface region 126.

Prior to the voltage being applied, the fluid is not positioned in the interface region 126. As such, the light propagating in the first waveguide 108 is reflected into the second waveguide 112.

The transit time represents the minimum amount of time that must be allowed between successive transfers and 1/Tₜᵣ is the maximum switching rate for continuous transfer of a fluid. Sustained fluid transports over thousands of cycles at switching rates in the order of a KHz are possible.

FIG. 3 is a top view of the optical switch of FIG. 1 and FIG. 2 that realize the elimination of the reflective interface and the attaining of transmission of the light through the first waveguide 108 when the fluid is moved into the intersection of the optical waveguides by the EHD pump 120. As is shown, once the EHD pump 120 moves the fluid 104 into the intersection 124, the refractive indices are matched and the optical signal is conveyed through the optical waveguide 108.

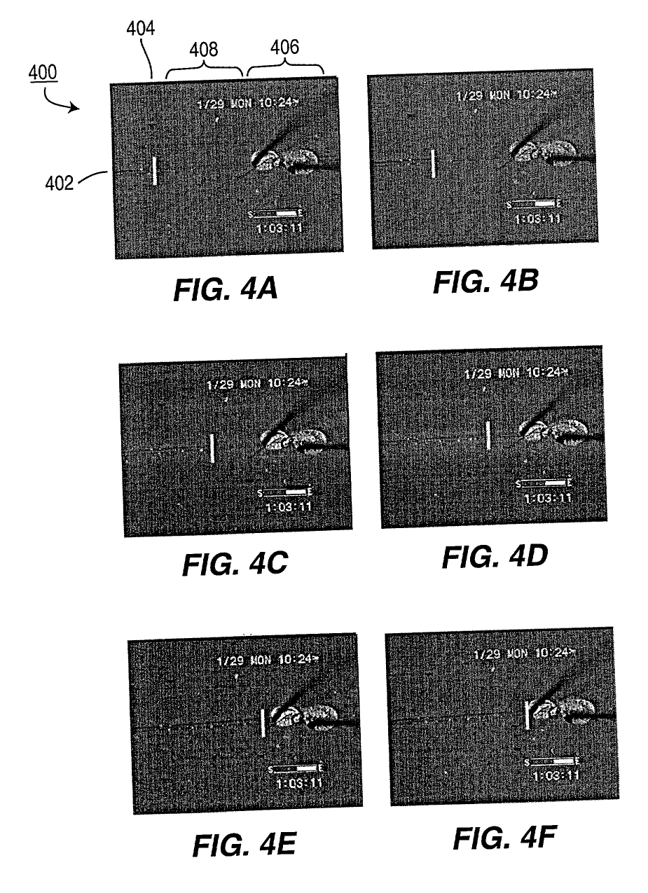

FIGS. 4A-4F shows sequence position of an air/fluid interface during fluid movement by using the EHD pump. FIG. 4A depicts the beginning of the sequence wherein the fluid is measured from a significant distance away from an intersection region. The fluid is located in a channel behind the air/fluid interface and all movement takes place within the channel.

FIG. 4B-4F depicts the sequence wherein the electrohydrodynamic actuator has been activated and the fluid moves toward the intersection as noted by the position of the air/fluid interface. As the electrohydrodynamic actuator is actuated, the electrodes of the electrohydrodynamic actuator create an electric field in the channel and begin to cause movement of the fluid. The fluid is traveling at approximately 1 mm/sec.

FIG. 4C shows further progression by the fluid under the control of the electrohydrodynamic actuator. As can be seen in FIG. 4C, the position of the air/fluid interface has changed from FIG. 4B and is continually moving toward the intersection. The electrohydrodynamic force at work is used to both push and pull the fluid from one position to another.

FIG. 4D shows further movement of the fluid as noted by the position of the air/fluid interface. In this frame of the sequence, the air/fluid interface line has moved more than three-quarters of the distance from which it started at the beginning of the sequence. The timeframe in which this is moved is still under one second.

FIG. 4E shows the continued fluid movement as the air/fluid interface moves further toward the intersection. At this point, the fluid, as noted by the position of the air/fluid interface, has almost reached the intersection and its final position. The time interval for this sequence is still measured in milliseconds.

Lastly, FIG. 4F shows the fluid at the end of the electrohydrodynamic movement sequence. The fluid has moved a substantial distance in a fraction of a second. At this point in the electrohydrodynamic actuator sequence, the air/fluid interface has moved to its final point and the sequence has ended. The light has been switched from the output of waveguide 110 to the output of waveguide 108.

FIG. 5 is a top view of another embodiment of the optical switch according to the present invention. This embodiment is similar in both function and appearance to the previous embodiment with the addition of an extended waveguide 512. This embodiment contains all of the features of the previous embodiment including a plurality of waveguides 508 and 512, an EHD pump 520, a fluid 504 disposed in a microchannel 502. All physical properties, the method of fabrication and dimensional characteristics are similar to that of the previously described embodiments. This embodiment allows for a second input source to propagate a signal 526 originating at and traveling through waveguide 512.

While this invention has been described with an emphasis upon preferred embodiment, it will be apparent to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed is:

1. An apparatus for switching an optical signal comprising:
a first optical waveguide;
a second optical waveguide intersecting said first waveguide at an intersection region;
a microchannel containing a fluid, intersecting the first and second waveguides at the intersection region; and
an electrode-based pump positioned in the microchannel for moving the fluid in and out of the intersection region.

2. The apparatus of claim 1, wherein the first and second optical waveguides are coplanar.

3. The apparatus of claim 1, wherein the first and second optical waveguides are formed in a substrate.

4. The apparatus of claim 1, wherein the electrode-based pump is an electrohydrodynamic pump further comprised of a plurality of electrodes electrically connected to a voltage source.

5. The apparatus of claim 1, wherein the electrode-based pump is an electro-osmosis pump.

6. The apparatus of claim 1, wherein said intersection region has a side wall at angles relative to axes of said first and second waveguide segments such that light reflected from said side wall when said fluid is transported into said intersection region from said end of said first waveguide segment into said end of said second waveguide segment, said switching element further comprising a third waveguide segment that is axially aligned with said first waveguide segment such that the light from the first waveguide segment enters said third waveguide segment when said fluid occupies said intersection region.

7. The apparatus of claim 1, wherein said electrode-based pump is in physical contact with the volume of said fluid to move in response to electrical activation of said electrode-based pump, said fluid moving in response to activation of said electrode-based pump, said electrode-based pump being positioned relative to said intersection region such that said first movement of said fluid is transported within said intersection region.

8. The apparatus of claim 1, wherein the angle of incidents of the first waveguide segment on said intersection region is between 60° and 90°.

9. A switching element for use along an optical path comprising:
(a) a substrate;
(b) a first optical waveguide segment having a first end;
(c) a second optical waveguide segment having a second end, said second end and said first end intersecting a microchannel;
(d) a fluid disposed within said microchannel, said fluid having an index of refraction such that optical transmission from said first optical waveguide segment to said second optical waveguide segment is determined by the presence of said fluid within said microchannel; and
(e) an electrohydrodynamic (EHD) pump having at least two electrodes, said electrodes having two respective ends, one of each of said electrodes ends being disposed in said microchannel, the other end of said electrode being electrically connected to a voltage source to displace said fluid in the microchannel.

10. A switching element for use along an optical path as described in claim 9, wherein said fluid further comprises a composite fluid of at least two immiscible fluids whereby one fluid acts as a transport plug to be moved by the electrohydrodynamic (EHD) pump and the other fluid includes a matching refractive index feature that corresponds to that of the optical waveguide.

11. A fluidic switching element for use in an optical switch comprising:
(a) a first optical waveguide formed onto a surface of the substrate;
(b) a second optical waveguide formed on said surface of said substrate and intersecting said first waveguide at an intersection region;
(c) a microchannel formed across said first and second waveguide at said intersection region;
(d) a liquid selectively disposed is said microchannel; and
(e) an electro-osmosis actuator apparatus for removing said liquid into said intersection, whereby a light signal propagating on said first optical waveguide continues in said first optical waveguide across said intersection region as the liquid's refracted index matches the waveguide's refractive index.

12. A fluidic switching element as claimed in claim 12 further comprising a set of electrodes in communication with said fluid.

13. A fluidic switching element as claimed in claim 12, wherein said liquid has an index of refraction substantially matching an index of refraction of said first and second waveguides.

14. A fluidic switching element as claimed in claim 12, wherein said electro-osmosis actuator moves said liquid in said channel.

15. A fluidic switching element as claimed in claim 15 further comprising a plurality of electrodes coupled to the electro-osmosis actuator.

16. A fluidic switching element as claimed in claim 12 further comprising a voltage source electrically coupled to said electro-osmosis actuator.
